(19) United States
(12) Patent Application Publication
(10) Pub. No.: US 2024/0303575 A1
(43) Pub. Date: Sep. 12, 2024

(54) System and Method for Enforcing Service Levels of Multiple Communication Channels in a Networked Computing Call Center

(71) Applicant: Talkdesk, Inc., San Francisco, CA (US)

(72) Inventors: Zheng YAN, Wuhan City (CN); Shuanhu WANG, Mountain View, CA (US); Ning ZHANG, Wuhan City (CN); Wenqiang ZHOU, Wuhan (CN); Shaohua CAI, Wuhan City (CN)

(21) Appl. No.: 18/117,926

(22) Filed: Mar. 6, 2023

(51) Int. Cl. G06Q 10/0639; G06Q 10/109; G06Q 30/015

(52) U.S. Cl. CPC G06Q 10/06393; G06Q 10/109; G06Q 30/015

(57) ABSTRACT

Disclosed implementations provide a time limit monitoring method and system for ticket control in a call center computing environment. The implementations include novel data models for affecting the method and system. The time limit monitoring method of the disclosed implementations dynamically generates a service level agreement template, which can be applied to improve the flow speed of the ticket to meet service level agreements.

### BACKGROUND

Cloud-based networked contact centers, also referred to as “call centers”, are well-known. In such call centers, service agents are assigned to queues based on skills and customer requirements. FIG. 1 is an example system architecture 100, of cloud-based call center environment. Customers 110 interact with contact center 150 to communicate with the agents 120 through a network 130 and at least one or more of text, email, voice or multimedia channels. Communication routing system 140 controls the routing and handling of communications between customers 110 and agents 120 for the contact center 150. Communication routing system 140 could be any of a contact center as a service (CCaS) system, an automated call distributor (ACD) system, or a case system, for example.

Agents 120 may be remote from contact center 150 and handle communications (also referred to as “interactions” or “calls” herein) with customers 110 on behalf of an enterprise. Agents 120 may utilize devices, such as but not limited to, workstations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network (LAN). The network types are provided by way of example and are not intended to limit types of networks used for communications.

Agents 120 may be assigned to one or more queues representing call categories and/or agent skill levels. The agents 120 assigned to a queue may handle communications that are placed in the queue by the communication routing system 140. For example, there may be queues associated with a language (e.g., English or Chinese), topic (e.g., technical support or billing), or a particular country of origin. When a communication is received by the communication routing system 140, the communication may be placed in a relevant queue, and one of agents 120 associated with the relevant queue may handle the communication.

Agents may be assigned to one or more entities using the cloud-based contact center. Therefore, it is possible that agents, on any given day or shift, are providing support/service for customers of various entities. For example, an agent may handle a communication from a customer of a computer supplier and then immediately thereafter handle a communication from a customer of an automobile company. Accordingly, agents might not be trained in all aspects of customer service for each entity. The term “customer”, as used herein, refers to the party contacting the call center for support or other information and includes actual customers, potential customers, or any other party contacting the call center. Further, agents may be employees of the call center provider, employees of the entity using the call center service, contractors, or freelancers. Of course, it is desirable to provide a specified “service level” for communications. A service level is usually defined by a Service Level Agreement (SLA), which is an agreed upon measure of the response and resolution times that a support team delivers to customers.

In view of increasing scale and business volume of the call center industry, the number of users and business volume of call center operators are increasing, and the utilization rate of end-to-end ticket systems has also increased rapidly. A “ticket” is a work document that records the circulation of work tasks between departments during the work process. For example, a ticket can track the origin, tasks, and resolution relating to a customer technical or billing problem. In conventional systems, there is a lack of dynamic, unified, public and standardized control solutions for ticket management. This results in the untimely control of tickets, low control efficiency, poor service levels, and thus low customer satisfaction. Tickets are tracked by ticket system 152

Additionally, conventional SLA systems only supports a single channel for each workflow and cannot accommodate complex omnichannel situations. For example, in one example a government entity might receive thousands of communications related to various subjects through asynchronous channels, such as emails, texts and voicemails, and government staff might need to respond to each these communications by a phone call, a synchronous channel. Effectively managing service levels in such a situation is a complex process which requires a dynamic and flexible solution that is not available in conventional systems.

### BRIEF SUMMARY

Disclosed implementations provide a time limit monitoring method and system for ticket control in a call center computing environment. The implementations include novel data models for affecting the method and system. The time limit monitoring method of the disclosed implementations dynamically generates a service level agreement template, which can be applied to improve the flow speed of the ticket to meet service level agreements.

One disclosed implementation is a method for processing omnichannel communications in a call center in accordance with a service level agreement (SLA), the method comprising: creating a ticket data structure that is configured to record a circulation of predefined tasks to be accomplished by one or more call center agents on behalf of a customer, wherein the ticket data structure includes a customer level information field, a product information filed, and a priority information field relating to the predefined tasks; receiving omnichannel communications data relating to multiple communications related to the predefined tasks, wherein the communications are accomplished over more than one type of communication channel; classifying each of the messages into at least one standardized type of communication channel; selecting a rules template corresponding to each of the standardized types and characteristics of the communication; applying at least one rule specified by each template to the corresponding types of messages based on the classification step; updating the ticket based on the results of the applying; extracting customer information from the customer level data field, the product information field, and the priority information field; applying a preconfigured service level template to each flow link of the ticket, wherein each service level template specifies a time limit and a communications channel; setting a reminder method and a reminder frequency for each communication chain of the ticket according to the time limit value specified by the corresponding service level template; selecting an SLA template for the ticket based on a corresponding reminder method, reminder frequency, and time limit value for each flow link of the ticket; and determine a time duration for accomplishing each of the predefined tasks in accordance with the time limit values.

### BRIEF DESCRIPTION OF THE DRAWING

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 is a block diagram of a computer architecture of a conventional call center environment.

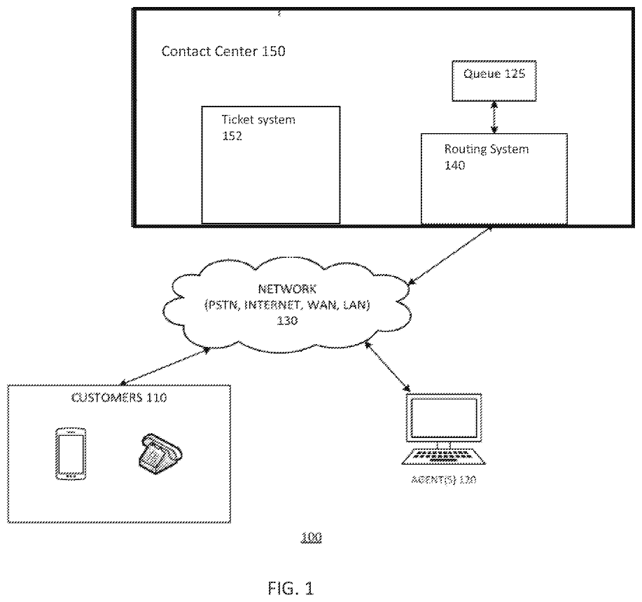

FIG. 2 is a flow chart of a method for generating SLA metrics in accordance with disclosed implementations.

FIG. 3 is a block diagram of a computer contact center including a ticket system in accordance with disclosed implementations.

FIG. 4 illustrates a UI for creating SLA templates in accordance with disclosed implementations.

FIG. 5 illustrates at UI for creating automation rules in accordance with disclosed implementations.

FIG. 6 illustrates a flow chart of SLA enforcement over the lifecycle of a ticket in accordance with disclosed implementations.

### DETAILED DESCRIPTION

Certain terminology is used in the following description for convenience only and is not limiting. Unless specifically set forth herein, the terms “a,” “an” and “the” are not limited to one element but instead should be read as meaning “at least one.” The terminology includes the words noted above, derivatives thereof and words of similar import.

Providing support based on service levels ensures that you're measured and predictable service is provided and also provides greater visibility when problems arise. However, various types of communications and communication channels warrant various levels of service. A mechanism for defining and enforcing service levels in a call center in a dynamic, flexible and scalable manner is needed.

Disclosed implementations provide a time limit monitoring method and system for ticket control, including novel data models for affecting the method and system. The time limit monitoring method of the disclosed implementations dynamically selects a service level template(s) for various communication channels in a ticket, which can be applied to improve the flow speed of the ticket.

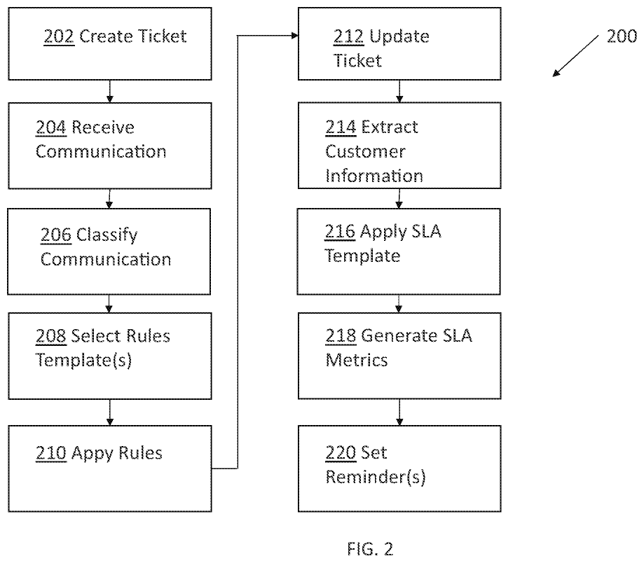

FIG. 2 illustrates a process for managing service levels in ticket workflows. The phrase “ticket workflow” as used herein, relates to communications and tasks associated with a ticket over the lifecycle of the ticket. As shown in FIG. 2, process 200 begins at 202 by creating a ticket data structure that is configured to record a circulation of tasks accomplished by one or more call center agents on behalf of a customer. Conventionally, a ticket is automatically created in response to a first communication between agent and customer related to specific issue. The ticket data structure can include a customer level information field, a product information field, and a priority information field relating to the predefined tasks. At step 204, omnichannel communications data relating to additional communications corresponding to the ticket are received. “Omnichannel” means that the communications are accomplished over more than one type of communication channel. At 206, each of the communications are classified into at least one standardized type of communication channel. Step 206 can include classifying received communications into standardized types, e.g. sync channel, and async channel. For different standardized type channels, different template calculation rules can be used. Transforming complex omnichannel messages into template scenarios reduces the computational resources required to access and process channels.

At 208, a corresponding rules template corresponding to each of the standardized communication types and characteristics of the communications is selected. For example, a rules template can specify the following rules:
A sync channel type can have 2 metrics (Requester wait time, Agent work time).
An async channel can have 4 metrics (First response time, Next response time, Requester wait time, Agent work time).

It can be seen that the rules template includes conditions for a channel such as metrics that are relevant for the channel of communication. At 210, at least one rule specified by each rules template is applied to the corresponding types of messages based on the classification step, to enforce a response time for example. At 212, the ticket is updated based on the results of applying the rule. For example, the ticket can be updated with a response time for a communication. At 214, customer information is extracted from a customer level data field, the product information field, and the priority information field. Step 214 can include extracting customer information, product information and priority information from the ticket. The customer information, product information and priority information can be identified and analyzed respectively to obtain customer level, product category and degree of urgency. At 216, a preconfigured service level template is select by matching ticket fields with corresponding fields, such as assignees, of the templates and the selected SLA template is applied to each flow link of the ticket, wherein each service level template specifies a time limit and a communications channel. After each ticket update, the conditions can be rematched. The SLA template provides values for the metrics. For example, an SLA template can specify:
Condition: Type is Question
Metrics: First response time to 1 min in Urgent type; Agent work time to 24 h in Urgent type.

In this example, if an email channel communication is received with a question (i.e., type=Question) it can be matched to this SLA template generating two metrics: First response time to 1 min, and Agent work time to 24 h. If the communication is a voice channel communication, it can be marched to this SLA template and only generates one metric, Agent work time to 24 h (because no initial/confirmation response is need to a synchronous channel communication).

At 218, SLA metrics, including time limits, are generated based on the selected SLA template. In the example above, the metrics can include setting agent work time to 24 hours when the communication is urgent. At 220 a reminder method and a reminder frequency for each communication chain of the ticket is specified based on the SLA metrics and applied according to the time limit value specified by the corresponding service level template. For example, an agent could be sent a reminder 4 hour prior to expiration of the specified agent work time. Step 218 generates the service level metrics according to the specified time limit value, the reminder method and the frequency of the reminder.

Step 220 uses the time limit value of pre-configured template of each flow link of the ticket during the circulation process according to the customer level, product category, the degree of urgency and other attributes to set the reminder method and frequency of each step according to the specified time limit value.

The process and data structure described above allows identification and processing of the customer information, product information and priority information in the ticket, and configuration of the corresponding time limit value for each flow accordingly, and further allows independently setting the reminder method and reminder frequency for each step according to the time limit value of each step. This results in a more flexible and targeted monitoring of each step to thereby improve the efficiency of achieving desired service levels in an automated call center system.

When a ticket flows to any step, the notification message of the ticket to reach the step is automatically sent by ticketing system 152. The time limit value, the reminder method and reminder frequency of the ticket is extracted from the service level agreement template. When the ticket reaches the step and the ticket has not been processed, it is determined whether the time taken has reached the specified time limit value. Further, the time limit monitoring of an average duration of the ticket in each step according to the time and time limit value of the ticket in each step can be calculated. By monitoring the status of tickets in real time and reminding relevant personnel to process them in time, the processing efficiency of tickets can be improved tickets can be processed in accordance with SLAs.

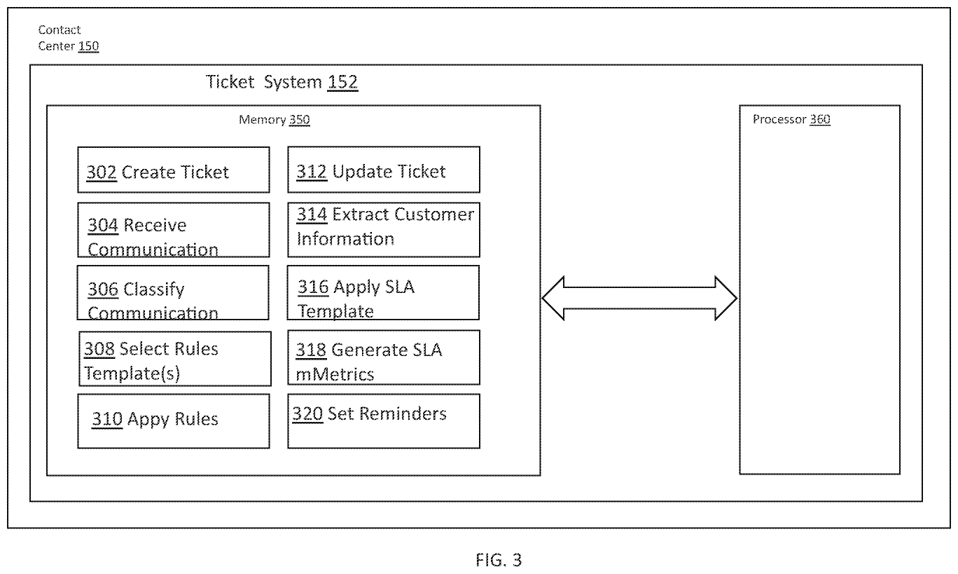

FIG. 3 illustrates ticket system 152 in greater detail. Ticket system 152 includes memory 350 and hardware processor 360. Memory 35 stores executable instructions, in the form of modules, which, when executed by processor 360, cause processor 360 to accomplish the steps illustrated in FIG. 2. Each module is labeled in correspondence to steps in FIG. 2, but having a first digit of “3” instead of “2”. The term “module” as used herein included executable instructions stored in memory and the processor resources necessary to execute the instructions. The modules are segregated by function for ease of description herein but need not be discrete and/or distinct code portions.

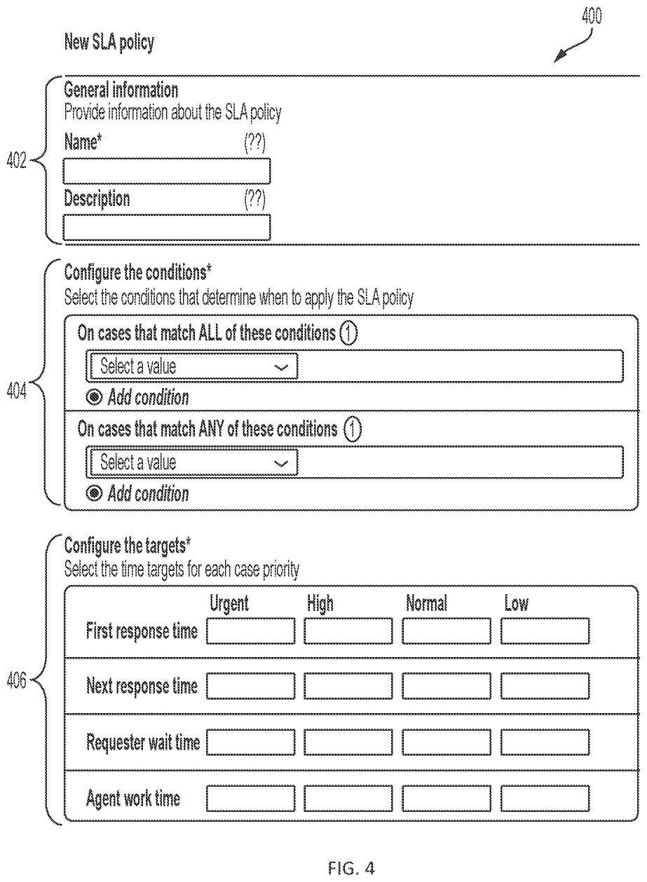

As noted above, a preconfigured service level template is applied to each flow link of the ticket, wherein each service level template specifies a time limit and a communications channel. The templates can be created based on various service level criteria. The criteria can be set by setting conditions and targets in a user interface (UI) such as UI 400 shown in FIG. 4. Descriptive information relating to a template, such as a template name and description, can be entered in the data fields at 402. Conditions can be configured by entering various conditions in the data fields at 404. Examples of conditions include:
Type is Question;
Group is agent;
Requester;
Product;
Creation dates; and
Other custom field conditions.

The data fields at 406 can be used to enter “targets”, e.g., target or required response times. For example, targets can include response times for various levels of priority and various communications in the ticket as shown at 406. The response times can be expressed in elapsed time, number of business days, or in any other manner.

As one example, if one condition is “Type is Question” and the target is “Up to 24 h for Urgent communications, the agent will be given 24 hours for responding to a question that is urgent priority in the ticket, regardless of the type of channel of the communication. A simple example of a data structure for this template is set forth below.
<type>=question
<target>=24 h

As another example, if conditions include the tag Talkdesk and target includes first response time to 24 h in Urgent communications, the SLA for tickets whose Tags contains Talkdesk and the priority is Urgent, if it is an async channel, the time limit is 24 hours. Applying templates results in setting a reminder method and a reminder frequency for each flow link of the ticket according to the time limit value specified by the corresponding service level template.

All SLA templates are stored in a database. A more detailed example data model for SLA templates is set forth below.

| Condition | Operator | Description |
|---|---|---|
| Case: Form | Is | Case forms are available as conditions. Select a specific form. |
| | Is not | |
| Case: Type | Is | Case type values. Value |
| | Is not | |
| Case: Source | Is | The case source is where and how the case was created. The contents of this list will |
| | Is not | differ depending on the channels you have active, and any integrations you are using. |
| | | For more information about the source you can configure. |
| Case: Group | Is | The group values are (Is/Is not): |
| | Is not | Group name is the actual name of the group that is assigned to the case. |
| | Is empty | |
| | Is not | |
| | empty | |
| Case: Assignee | Is | Admin can search agents from a search box. |
| | Is not | The assignee values are (Is/Is not): |
| | Is empty | (requester) is the case requester. You can select this option to return cases that were |
| | Is not | opened by and then assigned to the same agent. |
| | empty | Agent name is a list of agents in the system. |
| Case: Requester | Is | Admin can search agents from a search box. |
| | Is not | The requester values are: |
| | | (ASSIGNEE) is the person assigned to the case. The condition statement ‘Requester is |
| | | Assignee’ is true if the requester is also the person assigned to the case. This is possible |
| | | if an agent created a case and was then assigned to it. |
| | | Agent name is a list of agents in the system. |
| Case: Created | Is | The date of case was created. Date selection box |
| | Before and | |
| | on | |
| | After and | |
| | on | |
| Case: Role | Is | The requester role values are: |
| | Is not | (agent) the role of requester is agent |
| | | (contact) the role of requester is end user |
| | | (admin) the role of requester is is admin |
| Checkbox custom | Is | The values are: |
| fields | | Checked |
| | | Unchecked |
| Date custom | Is | date selection box |
| fields | Is not | |
| | Before and | |
| | on | |
| | After and | |
| | on | |
| Dropdown | Is | Custom fields dropdown selection for Is and Is not operator. |
| custom fields | Is not | |
| | Is empty | |
| | Is not | |
| | empty | |
| Multi-select | Contains | Multi-select dropdown for “Contain” and “Does not contain” operator |
| custom fields | Does not | Contains: contains at least one selection |
| | contain | Does not contain: does not contain any selection |
| | Is empty | |
| | Is not | |
| | empty | |
| Number custom | Is | number input box |
| fields | Is not | |
| | Is empty | |
| | Is not | |
| | empty | |
| | < | |
| | <= | |
| | > | |
| | >= | |
| Text/Multi-text | Is | text and multi-text input box |
| custom fields | Is not | |
| | Is empty | |
| | Is not | |
| | empty | |

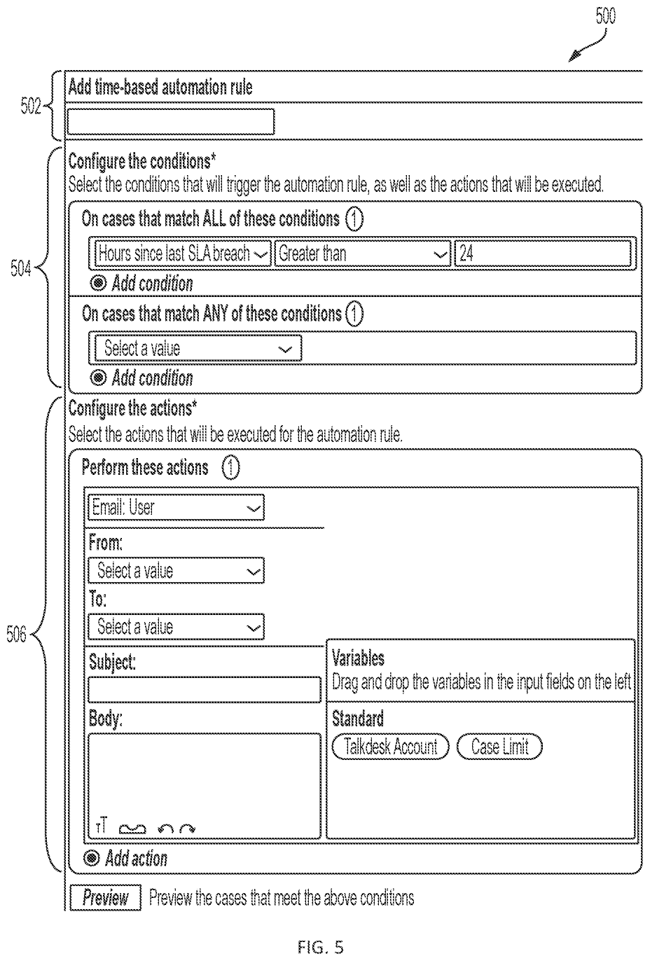

FIG. 5 illustrates UI 500 for configuring automation in accordance with disclosed implementations. Time-based automation is a downstream part of SLA, which enriches contact center functionality. For example, automation can include a corresponding reminder method for SLA systems, reminder frequencies are set by the automation system which can be separate from the SLA. The automation system can monitor SLA metrics and, send reminders based on the breach of SLA times. An automation rule name can be entered I the data filed at 502. Conditions can be configured in the data fields at 504 and actions can be configured in the data fields at 506.

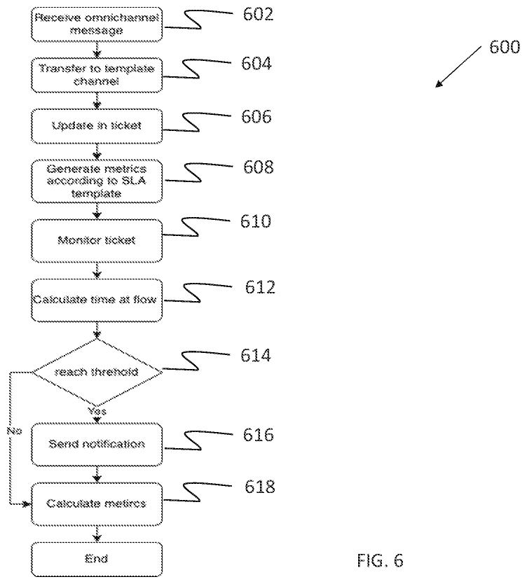

FIG. 6 illustrates method 600 for enforcing an SLA for a ticket. At 602, omnichannel messages corresponding to a ticket are received. At xx04, messages are transferred to a template channel. If a channel type is Email, the message is transferred it to an async channel. If the channel type is Voice, the message is transferred to a sync channel. As noted above, rules can be selected based on channel type. For example, for sync channels, the rule is that we only calculate Requester wait time and Agent work time, and for async channels, we calculate First Response Time, Next Response Time, Requester Wait Time, and Agent Work Time. At 606, the ticket is updated based on the communication content. For example, if the agent sent a message and resolved the conversation, then ticket status can be changed to “resolved.” At 608, SLA metrics are generated according to the SLA template. After the ticket properties are updated, the conditions need to be rematched to potential SLA templates and the correct SLA template is identified/selected for the ticket based on the matching. This can be accomplished by extracting customer information to match the conditions in the manner described above. Then the correct SLA template is applied according to the condition match result.

At 610, the ticket is monitored, and reminders are set according to the SLA metrics. As time goes by, it will be determined if the metrics' time limits are breached. At 612, time at flow is calculated. Every time the ticket is updated. The SLA template can be rematched the metrics can be calculated again. At 614, is it determined if a specified time threshold has been reached. If yes, a notification is sent at 616. If no, metrics are recalculated at 618.

It will be appreciated by those skilled in the art that changes could be made to the disclosed implementations without departing from the broad inventive concept thereof. It is understood, therefore, that this invention is not limited to the disclosed implementations, but it is intended to cover modifications within the spirit and scope of the present invention as defined by the appended claims.

What is claimed:

1. A method for processing omnichannel communications in a call center in accordance with a service level agreement (SLA), the method comprising:
creating a ticket data structure that is configured to record a circulation of predefined tasks to be accomplished by one or more call center agents on behalf of a customer, wherein the ticket data structure includes a customer level information field, a product information filed, and a priority information field relating to the predefined tasks;
receiving omnichannel communications data relating to multiple communications related to the predefined tasks, wherein the communications are accomplished over more than one type of communication channel;
classifying each of the messages into at least one standardized type of communication channel;
selecting a rules template corresponding to each of the standardized types and characteristics of the communication;
applying at least one rule specified by each template to the corresponding types of messages based on the classification step;
updating the ticket based on the results of the applying;
extracting customer information from the customer level data field, the product information field, and the priority information field;
applying a preconfigured service level template to each flow link of the ticket, wherein each service level template specifies a time limit and a communication channel;
generating an SLA metrics for the ticket based on a corresponding reminder method, reminder frequency, and time limit value for each flow link of the ticket;
determining a time duration for accomplishing each of the predefined tasks in accordance with the time limit values; and
setting a reminder method and a reminder frequency for each communication chain of the ticket according to the time limit value specified by the corresponding service level template.

2. The method of claim 1, wherein the communication channel is a voice channel and wherein the at least one rule is based on a customer wait time for the communication and agent work time.

3. The method of claim 1, wherein the communication channel is an asynchronous communication channel including one of email, chat, and text communication channels and wherein the at least one rule is based on first response time, next response time, customer wait time, and agent work time.

4. The method of claim 1, wherein the rules template specifies metrics for a communication channel.

5. The method of claim 6, wherein the service level template specifies values for the metrics.

6. The method of 7, wherein the value for the metric indicate or more values corresponding to Problem, Question, and/or Billing Issue.

7. A system for processing omnichannel communications in a call center in accordance with a service level agreement (SLA), the system comprising:
a computer processor; and
a memory device storing instructions which, when executed by the computer processor, cause the computer processor to carry out a method of:
creating a ticket data structure that is configured to record a circulation of predefined tasks to be accomplished by one or more call center agents on behalf of a customer, wherein the ticket data structure includes a customer level information field, a product information filed, and a priority information field relating to the predefined tasks;
receiving omnichannel communications data relating to multiple communications related to the predefined tasks, wherein the communications are accomplished over more than one type of communication channel;
classifying each of the messages into at least one standardized type of communication channel;
selecting a rules template corresponding to each of the standardized types and characteristics of the communication;
applying at least one rule specified by each template to the corresponding types of messages based on the classification step;
updating the ticket based on the results of the applying;
extracting customer information from the customer level data field, the product information field, and the priority information field;
applying a preconfigured service level template to each flow link of the ticket, wherein each service level template specifies a time limit and a communication channel;
generating an SLA metrics for the ticket based on a corresponding reminder method, reminder frequency, and time limit value for each flow link of the ticket;
determining a time duration for accomplishing each of the predefined tasks in accordance with the time limit values; and
setting a reminder method and a reminder frequency for each communication chain of the ticket according to the time limit value specified by the corresponding service level template.

8. The system of claim 7, wherein the communication channel is a voice channel and wherein the at least one rule is based on a customer wait time for the communication and agent work time.

9. The system of claim 7, wherein the communication channel is an asynchronous communication channel including one of email, chat, and text communication channels and wherein the at least one rule is based on first response time, next response time, customer wait time, and agent work time.

10. The system of claim 7, wherein the rules template specifies metrics for a communication channel.

11. The system of claim 10, wherein the service level template specifies values for the metrics.

12. The system of 11, wherein the value for the metric indicate or more values corresponding to Problem, Question, and/or Billing Issue.
